(19) United States
(12) Patent Application Publication
(10) Pub. No.: US 2020/0254616 A1
(43) Pub. Date: Aug. 13, 2020

(54) Robotic Cooking Device

(71) Applicant: Ali Ebrahimi Afrouzi, San Jose, CA (US)

(72) Inventor: Ali Ebrahimi Afrouzi, San Jose, CA (US)

(73) Assignee: AI Incorporated, Toronto (CA)

(21) Appl. No.: 16/275,115

(22) Filed: Feb. 13, 2019

(51) Int. Cl. B25J 9/16; G05D 23/19; F04D 27/00; G05D 1/02; F24C 1/16; B25J 13/00

(52) U.S. Cl. CPC B25J 9/1679; G05D 23/19; F04D 27/004; G05D 1/0268; B25J 9/1666; B25J 13/006; G05B 2219/50333; G05B 2219/45111; G05B 2219/50391; F24C 1/16

(57) ABSTRACT

Provided is a robotic cooking device including: a chassis; a set of wheels; a processor; an actuator; one or more sensors; one or more motors; and one or more cooking devices. An application of a communication device wirelessly connected to the robotic cooking device is used for one or more of: choosing settings of the robotic cooking device, choosing a location of the robotic cooking device, adjusting or generating a map of the environment, adjusting or generating a navigation path of the robotic cooking device, adjusting or generating boundaries of the robotic cooking device, and monitoring a food item within the one or more cooking devices.

### CROSS-REFERENCE TO RELATED APPLICATIONS

This application claims the benefit of Provisional Patent Application No. 62/630,150, filed Feb. 13, 2018; 62/667,977, filed May 7, 2018; 62/631,157, filed Feb. 15, 2018; 62/640/444, filed Mar. 8, 2018; 62/648,026, filed Mar. 26, 2018; 62/655,494, filed Apr. 10, 2018; 62/746,688, filed Oct. 17, 2018; 62/665,095, filed May 1, 2018; 62/674,994, filed May 21, 2018; 62/688,497, filed Jun. 22, 2018; 62/740,573, filed Oct. 3, 2018; 62/740,580, filed Oct. 3, 2018; 62/669,509, filed May 10, 2018; and 62/637,185, filed Mar. 1, 2018, all of which are hereby incorporated by reference.

In this patent, certain U.S. patents, U.S. patent applications, or other materials (e.g., articles) have been incorporated by reference. Specifically, U.S. application Ser. Nos. 15/272,752, 15/949,708, 16/048,179, 16/048,185, 16/163,541, 16/163,562, 16/163,508, 16/185,000, 62/681,965, 62/614,449, 16/109,617, 16/051,328, 15/449,660, 16/041,286, 15/406,890, 14/673,633, 16/219,647, 62/746,688, 62/740,573, 62/740,580, 15/955,480, 15/425,130, 15/955,344, 15/243,783, 15/954,335, 15/954,410, 15/257,798, 15/674,310, 15/224,442, 15/683,255, 62/664,389, 15/447,450, 15/447,623, 62/665,942, 62/617,589, 62/620,352, 15/951,096, 16/230,805, 16/127,038, 62/672,878, and 62/729,015, are hereby incorporated by reference. The text of such U.S. Patents, U.S. patent applications, and other materials is, however, only incorporated by reference to the extent that no conflict exists between such material and the statements and drawings set forth herein. In the event of such conflict, the text of the present document governs, and terms in this document should not be given a narrower reading in virtue of the way in which those terms are used in other materials incorporated by reference.

### FIELD

This disclosure relates to grills and smokers, and more particularly to grills and smokers including electronic components.

### BACKGROUND

Grills and smokers are a common household appliance. Electronic components can be purchased as add-on accessories for grills and smokers to facilitate the cooking process. An all- inclusive grill and smoking robot system including electronic components would be beneficial.

### SUMMARY

The following presents a simplified summary of some embodiments of the techniques described herein in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented below.

Provided is a robotic cooking device including: a chassis; a set of wheels; a processor; an actuator; one or more sensors; one or more motors; and one or more cooking devices.

### BRIEF DESCRIPTION OF THE DRAWINGS

FIG. 1 illustrates an example of a robotic cooking device, according to some embodiments.

FIG. 2 illustrates an example of a robotic cooking device, according to some embodiments.

### DETAILED DESCRIPTION OF SOME EMBODIMENTS

The present inventions will now be described in detail with reference to a few embodiments thereof as illustrated in the accompanying drawings. In the following description, numerous specific details are set forth in order to provide a thorough understanding of the present inventions. It will be apparent, however, to one skilled in the art, that the present invention may be practiced without some or all of these specific details. In other instances, well known process steps and/or structures have not been described in detail in order to not unnecessarily obscure the present invention. Further, it should be emphasized that several inventive techniques are described, and embodiments are not limited to systems implanting all of those techniques, as various cost and engineering trade-offs may warrant systems that only afford a subset of the benefits described herein or that will be apparent to one of ordinary skill in the art.

Some embodiments provide a robotic cooking device including a chassis, a cooking device coupled to the chassis, a set of wheels, a suspension system, one or more motors to drive the wheels, a processor, a power source, a memory, an actuator, and one or more electronic components that facilitate the cooking process. In some embodiments, the processor includes a system or device(s) that perform methods for receiving and storing data; methods for processing data, including depth data; methods for processing command responses to stored or processed data, to the observed environment, to internal observation, or to user input; methods for constructing a map or the boundary of an environment; and methods for navigation and other operation modes. For example, the processor may receive data from an obstacle sensor, and based on the data received, the processor may respond by commanding the robotic cooking device to move in a specific direction. As a further example, the processor may receive image data of the observed environment, process the data, and use it to create a map of the environment. The processor may be a part of the robotic cooking device, a camera, a navigation system, a mapping module or any other device or module. The processor may also be a separate component coupled to the robotic cooking device, the navigation system, the mapping module, the camera, or other devices working in conjunction with the robotic cooking device. More than one processor may be used. In some embodiments, the robotic cooking device includes a versatile robotic chassis that is customized to operate as a robotic cooking device. An example of a versatile robotic chassis is described in U.S. Patent Application No. 16/230,805, the entire contents of which is hereby incorporated by reference. Examples of cooking devices includes a grill, a smoker, an oven, a microwave, a crock pot, a smart pot, a stove, a hot plate, a warming oven, a fridge, a cooler, a freezer, a steamer, a deep fryer, a crock pot, a cooler, and other cooking devices. Examples of electronic components include an electronic fan, an electronic temperature sensor, a touch screen with graphical user interface, an electronic lid, and the like. Examples of wheels of a robotic device are described in U.S. Patent Application No. 62/664,389, 15/447,450, 15/447,623, and 62/665,942, the entire contents of which are hereby incorporated by reference. Examples of a suspension system are described in U.S. Patent Application Nos. 62/617,589, 62/620,352, and 15/951,096, the entire contents of which are hereby incorporated by reference. In some embodiments, the robotic device further includes a platform on which items are placed for carrying and transportation. In some embodiments, the robotic device further includes a user interface for, for example, adjusting settings, choosing functions, scheduling tasks. In some embodiments, the robotic device further includes a mapping module for mapping the environment using mapping methods such as those described in U.S. patent application Ser. Nos. 16/048,179, 16/048,185, 16/163,541, 16/163,562, 16/163,508, 16/185,000, 62/669,509, 62/637,185, 62/681,965, and 62/614,449, the entire contents of which are hereby incorporated by reference. In some embodiments, the robotic device further includes a localization module for localizing the robotic device using localization methods such as those described in U.S. Patent Application Nos. 62/746,688, 62/740,573, 62/740,580, 62/640,444, 62/648,026, 62/655,494, 62/665,095, 62/674,994, 62/688,497 15/955,480, 15/425,130, and 15/955,344 the entire contents of which are hereby incorporated by reference. In some embodiments, the robotic device further includes a path planning module to determine optimal movement paths of the robotic device based on the tasks of the robotic device using path planning methods such as those described in U.S. patent application Ser. Nos. 16/041,286, 15/406,890, and 14/673,633, the entire contents of which are hereby incorporated by reference. In some embodiments, the robotic device includes a scheduling module for setting a schedule of the robotic device using scheduling methods such as those described in U.S. patent application Ser. Nos. 16/051,328 and 15/449,660, the entire contents of which are hereby incorporated by reference. In some embodiments, the robotic device includes sensors such as cameras, LIDAR sensors, LADAR sensors, stereo imaging sensors, optical sensors, imaging sensors, distance sensors, acoustic sensors, motion sensors, obstacle sensors, cliff sensors, floor sensors, debris sensors, time-of-flight sensors, depth sensors, signal transmitters and receivers, signal strength sensor, gyroscope, optical encoders, optical flow sensors, GPS, and other types of sensors. In some embodiments, the robotic device includes a wireless module to wirelessly send and receive information, such as a Wi-Fi module or a Bluetooth module. In some embodiments, the robotic device includes an acoustic sensor to receive verbal commands. In some embodiments, the robotic device is similar to the item-transporting robotic device described in U.S. patent application Ser. No. 16/127,038, the entire contents of which is hereby incorporated by reference.

In some embodiments, the robotic cooking device includes an electronic fan for cooking. In some embodiments, the electronic fan includes a temperature sensor. In some embodiments, a desired cooking temperature is set using an input device of the robotic cooking device and the processor of the robotic cooking device autonomously activates and deactivates the fan to maintain the desired cooking temperature. In some embodiments, the processor autonomously adjusts the fan speed to maintain the desired cooking temperature. In some embodiments, the electronic fan is positioned at a bottom inlet of the electronic grill and smoker system.

In some embodiments, the robotic cooking device includes one or more electronic temperature sensors. In some embodiments, an electronic temperature sensor is used to monitor the temperature of a food item or the heat source or other temperatures of the robotic cooking device. In some embodiments, the processor of the robotic cooking device autonomously increases or decreases the temperature by adjusting the level of heat provided by the heat source or the speed of the electronic fan or another setting of the robotic cooking device capable of adjusting temperature. In some embodiments, the robotic cooking device includes one or more heat sources. Examples of heat sources includes charcoal briquettes, natural lump charcoal, propane, wood chunks, wood pellets, wood chips, natural gas, electric, and the like. In some embodiments, the processor of the robotic cooking device autonomously increases or decreases the temperature to maintain a desired temperature within the grill or within a food item. In some embodiments, an electronic infrared thermometer is used to monitor temperatures. For example, in some embodiments, an infrared thermometer coupled to the robotic cooking device is positioned such that it is aimed at a food item. In some embodiments, the processor of the robotic cooking device autonomously positions the infrared thermometer such that it is aimed at the food item by using distance sensors, computer vision technology, or other methods for locating the position of the food item. Examples of methods for measuring the distance to objects are described in U.S. patent application Ser. Nos. 15/243,783, 15/954,335, 15/954,410, 15/257,798, 15/674,310, 15/224,442, and 15/683,255, the entire contents of which are hereby incorporated by reference.

In some embodiments, the robotic cooking device includes an electronic lid. In some embodiments, the electronic lid is opened by activating a button on a user interface of the robotic cooking device or a motion sensor (e.g., waving to activate opening of the lid).

In some embodiments, the robotic cooking device includes a network card to provide wireless connectivity (e.g., Wi-Fi, Bluetooth, etc.) to the internet and or other devices. In some embodiments, the robotic cooking device wirelessly pairs with an application of a communication device (e.g., mobile phone, tablet, laptop, desktop computer, remote control, etc.). In some embodiments, the communication device is a dedicated communication device coupled to the robotic cooking device. Examples of pairing methods are described in U.S. patent application Ser. Nos. 16/109,617 and 62/667,977, the entire contents of which is hereby incorporated by reference. In some embodiments, a graphical user interface of the application of the communication device is used to adjust settings such as cooking settings or settings of electronic components and control operation of the robotic cooking device. Examples of a graphical user interface that can be adapted for use with the robotic cooking system are described in U.S. patent application Ser. Nos. 15/272,752, and 15/949,708, the entire contents of which are hereby incorporated by reference. Cooking settings may include, for example, cooking temperature, cooking duration, preheating time, scheduled time to turn on the cooking device to preheat, conditions for ending cooking (e.g., when the internal temperature of a food item reaches a predetermined temperature) or other settings relating to cooking of a food item. Settings of electronic components may include, for example, fan speed of an electronic fan, activating/deactivating electronic components, positioning of an infrared temperature sensor, and the like. In some embodiments, different settings can be set for different users for each of the electronic components or for each type of food.

In some embodiments, a food item is selected using the application of the communication device and default cooking settings and electronic component settings are used based on the food item selected. In some embodiments, cooking settings and electronic component settings are chosen for a particular food item and are saved using the application of the communication device such that the settings are automatically used when cooking the particular food item in the future. For instance, new cooking settings (e.g., 225 degrees for 10 hours) and electronic component settings (e.g., automatically adjust fan speed to maintain a temperature of 225 hours) are initially chosen and saved for smoked pulled pork using the application of the communication device. At a later time, smoked pulled pork is selected using the application of the communication device and the cooking and electronic components settings are automatically used for cooking.

In some embodiments, the application of the communication device provides suggestions to a user based on the type of food being cooked or preferences of a user (e.g., preferring a steak cooked rare or a chicken cooked until dry). For example, the application of the communication device suggests using a plate setter (an internal piece the user places inside the device which affects the type of cook) if the user prefers a food item be baked as opposed to grilled. In another example, the application of the communication device suggests using a cast iron grill top instead of a stainless steel grill top. In some embodiments, a suggestion is provided after a food item to be cooked is selected using the application of the communication device. For example, the application of the communication device suggests using a pizza stone if the food item selected for cooking is a pizza. Various suggestions are possible.

In some embodiments, the robotic cooking device includes a camera and a live video of one or more food items during the cooking process is streamed to the application of the communication device to provide the user with the ability of observing the one or more food item without having to open the lid, thereby reducing the loss of heat during the cooking process. In some embodiments, computer vision technology is used to determine cooking progress of a food item. For example, the processor of the robotic cooking device processes images captured by the camera of the robotic device and determines the cooking progress of a food item (e.g., steak, asparagus, etc.) based on the processed images.

In some embodiments, the processor of the robotic cooking device generates a map of an environment using mapping methods such as those described in U.S. patent application Ser. Nos. 16/048,179, 16/048,185, 16/163,541, 16/163,562, 16/163,508, 16/185,000, 62/681,965, and 62/614,449, the entire contents of which are hereby incorporated by reference. In some embodiments, a camera, installed on the robotic cooking device perceives depths from the camera to objects within a first field of view, e.g., such that a depth is perceived at each specified increment. Depending on the type of depth perceiving device used, depth may be perceived in various forms. The depth perceiving device may be a depth sensor, a camera, a camera coupled with IR illuminator, a stereovision camera, a depth camera, a time-of-flight camera or any other device which can infer depths from captured depth images. A depth image can be any image containing data which can be related to the distance from the depth perceiving device to objects captured in the image. For example, in one embodiment the depth perceiving device may capture depth images containing depth vectors to objects, from which the processor can calculate the Euclidean norm of each vector, representing the depth from the camera to objects within the field of view of the camera. In some instances, depth vectors originate at the depth perceiving device and are measured in a two-dimensional plane coinciding with the line of sight of the depth perceiving device. In other instances, a field of three-dimensional vectors originating at the depth perceiving device and arrayed over objects in the environment are measured. In another embodiment, the depth perceiving device infers depth of an object based on the time required for a light (e.g., broadcast by a depth-sensing time-of-flight camera) to reflect off of the object and return. In a further example, the depth perceiving device may comprise a laser light emitter and two image sensors positioned such that their fields of view overlap. Depth may be inferred by the displacement of the laser light projected from the image captured by the first image sensor to the image captured by the second image sensor (see, U.S. Patent Application No. 15/243,783, the entire contents of which is hereby incorporated by reference). The position of the laser light in each image may be determined by identifying pixels with high brightness (e.g., having greater than a threshold delta in intensity relative to a measure of central tendency of brightness of pixels within a threshold distance). Other depth measurement methods that may be used are described in U.S. patent application Ser. Nos. 15/954,335, 15/954,410, 15/257,798, 15/674,310, 15/224,442, and 15/683,255, the entire contents of which are hereby incorporated by reference.

In some embodiments, the robotic cooking device and attached camera rotate to observe a second field of view partly overlapping the first field of view. In some embodiments, the robotic cooking device and camera move as a single unit, wherein the camera is fixed to the robotic cooking device, the robotic cooking device having three degrees of freedom (e.g., translating horizontally in two dimensions relative to a floor and rotating about an axis normal to the floor), or as separate units in other embodiments, with the camera and robotic cooking device having a specified degree of freedom relative to the other, both horizontally and vertically. For example, but not as a limitation (which is not to imply that other descriptions are limiting), the specified degree of freedom of a camera with a 90 degrees field of view with respect to the robotic cooking device may be within 0-180 degrees vertically and within 0-360 degrees horizontally. Depths may be perceived to objects within a second field of view (e.g., differing from the first field of view due to a difference in camera pose). In some embodiments, the processor compares the depths for the second field of view to those of the first field of view and identifies an area of overlap when a number of consecutive depths from the first and second fields of view are similar, as determined with techniques such those described below. The area of overlap between two consecutive fields of view correlates with the angular movement of the camera (relative to a static frame of reference of a room) from one field of view to the next field of view. By ensuring the frame rate of the camera is fast enough to capture more than one frame of measurements in the time it takes the robotic device to rotate the width of the frame, there is always overlap between the measurements taken within two consecutive fields of view. The amount of overlap between frames may vary depending on the angular (and in some cases, linear) displacement of the robotic cooking device, where a larger area of overlap is expected to provide data by which some of the present techniques generate a more accurate segment of the floor plan relative to operations on data with less overlap. In some embodiments, the processor infers the angular disposition of the robotic cooking device from the size of the area of overlap and uses the angular disposition to adjust odometer information to overcome the inherent noise of an odometer. Further, in some embodiments, it is not necessary that the value of overlapping depths from the first and second fields of view be the exact same for the area of overlap to be identified. It is expected that measurements will be affected by noise, resolution of the equipment taking the measurement, and other inaccuracies inherent to measurement devices. Similarities in the value of depths from the first and second fields of view can be identified when the values of the depths are within a tolerance range of one another. The area of overlap may also be identified by the processor by recognizing matching patterns among the depths from the first and second fields of view, such as a pattern of increasing and decreasing values. Once an area of overlap is identified, in some embodiments, the processor uses the area of overlap as the attachment point and attaches the two fields of view to form a larger field of view. Since the overlapping depths from the first and second fields of view within the area of overlap do not necessarily have the exact same values and a range of tolerance between their values is allowed, the processor uses the overlapping depths from the first and second fields of view to calculate new depths for the overlapping area using a moving average or another suitable mathematical convolution. This is expected to improve the accuracy of the depths as they are calculated from the combination of two separate sets of measurements. The processor uses the newly calculated depths as the depths for the overlapping area, substituting for the depths from the first and second fields of view within the area of overlap. The processor uses the new depths as ground truth values to adjust all other perceived depths outside the overlapping area. Once all depths are adjusted, a first segment of the floor plan is complete. In other embodiments, combining depth data of two fields of view may include transforming vectors with different origins into a shared coordinate system with a shared origin, e.g., based on an amount of translation or rotation of a depth sensing device between frames, for instance, by adding a translation or rotation vector to depth vectors. The transformation may be performed before, during, or after combining. The method of using the camera to perceive depths within consecutively overlapping fields of view and the processor to identify the area of overlap and combine perceived depths at identified areas of overlap is repeated, e.g., until all areas of the environment are discovered and a floor plan is constructed.

In some embodiments, the processor identifies (e.g., determines) an area of overlap between two fields of view when (e.g., during evaluation a plurality of candidate overlaps) a number of consecutive (e.g., adjacent in pixel space) depths from the first and second fields of view are equal or close in value. Although the value of overlapping perceived depths from the first and second fields of view may not be exactly the same, depths with similar values, to within a tolerance range of one another, can be identified (e.g., determined to correspond based on similarity of the values). Furthermore, identifying matching patterns in the value of depths perceived within the first and second fields of view can also be used in identifying the area of overlap. For example, a sudden increase then decrease in the depth values observed in both sets of measurements may be used to identify the area of overlap. Examples include applying an edge detection algorithm (like Haar or Canny) to the fields of view and aligning edges in the resulting transformed outputs. Other patterns, such as increasing values followed by constant values or constant values followed by decreasing values or any other pattern in the values of the perceived depths, can also be used to estimate the area of overlap. A Jacobian and Hessian matrix can be used to identify such similarities. In some embodiments, thresholding may be used in identifying the area of overlap wherein areas or objects of interest within an image may be identified using thresholding as different areas or objects have different ranges of pixel intensity. For example, an object captured in an image, the object having high range of intensity, can be separated from a background having low range of intensity by thresholding wherein all pixel intensities below a certain threshold are discarded or segmented, leaving only the pixels of interest. In some embodiments, a metric, such as the Szymkiewicz-Simpson coefficient, can be used to indicate how good of an overlap there is between the two sets of perceived depths. Or some embodiments may determine an overlap with a convolution. Some embodiments may implement a kernel function that determines an aggregate measure of differences (e.g., a root mean square value) between some or all of a collection of adjacent depth readings in one image relative to a portion of the other image to which the kernel function is applied. Some embodiments may then determine the convolution of this kernel function over the other image, e.g., in some cases with a stride of greater than one pixel value. Some embodiments may then select a minimum value of the convolution as an area of identified overlap that aligns the portion of the image from which the kernel function was formed with the image to which the convolution was applied.

In some embodiments, the processor expands the area of overlap to include a number of depths perceived immediately before and after (or spatially adjacent) the perceived depths within the identified overlapping area.

Depending on the type of depth perceiving device used, depth data may be perceived in various forms. In one embodiment, the depth perceiving device may measure a vector to the perceived object and calculate the Euclidean norm of each vector, representing the depth from the camera to objects within the first field of view. The L^{P} norm is used to calculate the Euclidean norm from the vectors, mapping them to a positive scalar that represents the depth from the camera to the observed object. In some embodiments, this data structure maps the depth vector to a feature descriptor to improve frame stitching, as described, for example, in U.S. patent. application Ser. No. 15/954,410, the entire contents of which are hereby incorporated by reference. In some embodiments, the depth perceiving device may infer depth of an object based on the time required for a light to reflect off of the object and return. In a further example, depth to objects may be inferred using the quality of pixels, such as brightness, intensity, and color, in captured images of the objects, and in some cases, parallax and scaling differences between images captured at different camera poses. It is noted that each step taken in the process of transforming a matrix of pixels, for example, each having a tensor of color, intensity and brightness, into a depth value in millimeters or inches is a loss and computationally expensive compression and further reduces the state space in each step when digitizing each quality. In order to reduce the loss and computational expenses, it is desired and useful to omit intermediary steps if the goal can be accomplished without them. Based on information theory principal, it is beneficial to increase content for a given number of bits. For example, reporting depth in specific formats, such as metric units, is only necessary for human visualization. In implementation, such steps can be avoided to save computational expense and loss of information. The amount of compression and the amount of information captured and processed is a trade-off, which a person of ordinary skill in the art can balance to get the desired result with the benefit of this disclosure.

Structure of data used in inferring depths may have various forms. For example, a matrix containing pixel position, color, brightness, and intensity or a finite ordered list containing x, y position and norm of vectors measured from the camera to objects in a two-dimensional plane or a list containing time-of-flight of light signals emitted in a two-dimensional plane between camera and objects in the environment. For ease of visualization, data from which depth is inferred may be converted and reported in the format of millimeters or inches of depth; however, this is not a requirement, which is not to suggest that other described features are required. For example, pixel intensities from which depth may be inferred may be converted into meters of depth for ease of visualization, or they may be used directly given that the relation between pixel intensity and depth is known. To reduce computational expense, the extra step of converting data from which depth may be inferred into a specific format can be eliminated, which is not to suggest that any other feature here may not also be omitted in some embodiments. The methods of perceiving or otherwise inferring depths and the formats of reporting depths used herein are for illustrative purposes and are not intended to limit the invention, again which is not to suggest that other descriptions are limiting. Depths may be perceived (e.g., measured or otherwise inferred) in any form and be reported in any format.

Due to measurement noise, discrepancies between the value of depths within the area of overlap from the first field of view and the second field of view may exist and the values of the overlapping depths may not be the exact same. In such cases, new depths may be calculated, or some of the depths may be selected as more accurate than others. For example, the overlapping depths from the first field of view and the second field of view (or more fields of view where more images overlap, like more than three, more than five, or more than 10) may be combined using a moving average (or some other measure of central tendency may be applied, like a median or mode) and adopted as the new depths for the area of overlap. The minimum sum of errors may also be used to adjust and calculate new depths for the overlapping area to compensate for the lack of precision between overlapping depths perceived within the first and second fields of view. By way of further example, the minimum mean squared error may be used to provide a more precise estimate of depths within the overlapping area. Other mathematical methods may also be used to further process the depths within the area of overlap, such as split and merge algorithm, incremental algorithm, Hough Transform, line regression, Random Sample Consensus, Expectation-Maximization algorithm, or curve fitting, for example, to estimate more realistic depths given the overlapping depths perceived within the first and second fields of view. The calculated depths are used as the new depths for the overlapping area. In another embodiment, the k-nearest neighbors algorithm can be used where each new depth is calculated as the average of the values of its k-nearest neighbors. Some embodiments may implement DB-SCAN on depths and related values like pixel intensity, e.g., in a vector space that includes both depths and pixel intensities corresponding to those depths, to determine a plurality of clusters, each corresponding to depth measurements of the same feature of an object. In some embodiments, a first set of readings is fixed and used as a reference while the second set of readings, overlapping with the first set of readings, is transformed to match the fixed reference.

The robotic cooking device may, for example, use the floor plan map to autonomously navigate the environment during operation, e.g., accessing the floor plan to determine that a candidate route is blocked by an obstacle denoted in the floor plan, to select a route with a route- finding algorithm from a current point to a target point, or the like. In some embodiments, the floor plan is stored in memory for future use. Storage of the floor plan may be in temporary memory such that a stored floor plan is only available during an operational session or in more permanent forms of memory such that the floor plan is available at the next session or startup. In some embodiments, the floor plan is further processed to identify rooms and other segments. In some embodiments, a new floor plan is constructed at each use, or an extant floor plan is updated based on newly acquired data

Some embodiments may reference previous maps during subsequent mapping operations. For example, embodiments may apply Bayesian techniques to simultaneous localization and mapping and update priors in existing maps based on mapping measurements taken in subsequent sessions. In some embodiments, the processor of the robotic device localizes itself during mapping or during operation using robot localization methods such as those described in U.S. Patent Application Nos. 62/746,688, 62/740,573, 62/740,580, 15/955,480, 15/425,130, and 15/955,344 the entire contents of which are hereby incorporated by reference. In some embodiments, the processor localizes the robotic cooking device within a space, such as a phase space or Hilbert space. The space includes all possible states of the robotic cooking device within the space. In some embodiments, a probability distribution of a space, such as a phase or Hilbert space, may be used by the processor of the robotic cooking device to approximate the likelihood of the state of the robotic cooking device being within a specific region of the space. In some embodiments, the processor of the robotic cooking device determines a phase space probability distribution over all possible states of the robotic cooking device within the phase space of the robotic cooking device using a statistical ensemble. In some embodiments, the processor of the robotic cooking device may update the phase space probability distribution when the processor receives readings. Any type of reading that may be represented as a probability distribution that describes the likelihood of the state of the robotic cooking device being in a particular region of the phase space may be used. In some embodiments, the processor of the robotic cooking device may determine a probability density over all possible states of the robotic cooking device within a Hilbert space using a complex-valued wave function for a single-particle system. In some embodiments, the probability density of the Hilbert space may be updated by the processor of the robotic cooking device each time an observation or measurement is received by the processor of the robotic cooking device. In embodiments, wherein the state of the robotic cooking device within a space is initially unknown, the processor of the robotic cooking device may generate a uniform probability distribution over the space. In other instances, any other probability distribution may be generated depending on the information known about the state of the robotic cooking device and the certainty of the information. Over time and as more measurements and observations are received by the processor of the robotic cooking device, the probability distribution over all possible states of the robotic cooking device in the space evolves.

In some embodiments, the robotic cooking device moves while scanning a surrounding environment using a device capable of measuring depth or data from which depth can be inferred. In some embodiments, the processor of the robotic cooking device creates an initial low-resolution map of environment using a subset of the scans. In some embodiments, the processor initially assumes the robotic device is located somewhere within an area greater than the size of the robotic cooking device. The processor reduces the size of area when data is collected and increases the size of the area when the robotic device moves. As the robotic cooking device moves the processor adjusts the shape of the area based on deviation between the measured and true heading and translation of the robotic cooking device. In some embodiments, the processor assigns a likelihood of the robotic cooking device being located at each possible location of the robotic coking device within the area.

In some embodiments, the map of the environment is displayed using the application of the communication device and the graphical user interface of the application is used to select a particular location within the map of the environment for the robotic cooking device to navigate to. In some embodiments, a user captures an image of a particular location using a camera of a communication device and sends the image to the processor of the robotic cooking device. In some embodiments, the processor of the robotic cooking device processes the image and compares it to the map of the environment to determine the particular location captured in the image, then instructs the robotic cooking device to navigate to the location captured in the image. In some embodiments, a processor of the communication device processes the images and determines the location captured in the image. An example of a method for navigating a robotic device to a particular location using images or videos is described in U.S. patent application Ser. No. 16/219,647, the entire contents of which is hereby incorporated by reference. In some embodiments, the graphical user interface of the application is used to create a navigation path of the robotic cooking device to a particular location. In some embodiments, the processor of the robotic cooking device autonomously determines a navigation path to a particular location using path planning methods such as those described in U.S. patent application Ser. Nos. 16/041,286, 62/631,157, 15/406,890, and 14/673,633, the entire contents of which are hereby incorporated by reference.

In some embodiments, the robotic cooking device navigates to a particular location based on the weather conditions observed by one or more sensors of the robotic cooking device. For example, a robotic grill currently being used to cook meat navigates to an area of shelter using the map of the environment upon sensing rain by one or more sensors of the robotic grill. In another example, a robotic cooking device navigates to an area where minimal wind is sensed by one or more sensors of the robotic cooking device to improve the efficiency of the heating source. For example, the robotic cooking device may relocate itself from an open backyard to a covered area on a side of the house using the map of the environment to reduce the impact of wind during cooking. In some embodiments, the robotic cooking device navigates to a location within the environment specified using the application of the communication device.

In some embodiments, the graphical user interface of the application is used to adjust the map of the environment. For example, perimeters of the environment can be extended, trimmed, added, deleted or moved in any direction. In some embodiments, the graphical user interface of the application is used to create or adjust boundaries of the robotic cooking device such that it remains in particular areas of the environment.

In some embodiments, the robotic cooking device includes an alert system. In some embodiments, the alert is auditory and/or visual. For example, the alert may generate a noise, a warning message, activate a set of lights, a message that is sent to a communication device (e.g., mobile phone, tablet, laptop, remote control), etc. In some embodiments, the processor of the robotic cooking device activates the alert system when the robotic cooking device needs to be relocated due to weather conditions or uneven surface or potential smoke or heat damage to a covering (e.g., ceiling) above the robotic cooking device, cooking of a food item is complete, a food item needs to be rotated or flipped, the robotic cooking device is damaged or malfunctioning, the robotic cooking device is stuck or stalled, the robotic cooking device requires more heat source (e.g., natural gas), the robotic cooking device requires cleaning, a food item is almost cooked, a food item is overcooked, the cooking temperature requires adjusting, or for other reasons.

In some embodiments, the robotic cooking device includes a self-cleaning system. In some embodiments, a cleaning scheduling is predetermined (e.g., after a predetermined number of cooking hours or after every use) or is set using the application of the communication device. Examples of scheduling methods or inputting schedules are described in U.S. patent application Ser. Nos. 16/051,328, 15/449,660, 15/272,752, and 15/949,708, the entire contents of which are hereby incorporated by reference. The self-cleaning process can include, for example, burning a cook without any food at a high temperature to burn any grease or droppings which have accumulated and dropped off the cooking top or grease that has accumulated on the lid of the cooking device.

In some embodiments, the robotic cooking device autonomously empties ash if wood or charcoal is used as the heating source. In some embodiments, the robotic cooking device is provided with a disposal location using the application of the communication device. In some embodiments, the robotic cooking device uses one or more sensors to detect when a maximum ash volume has been reached and the robotic cooking device navigates to the disposal location to dispose the ash upon detecting that the maximum ash volume has been reached.

In some embodiments, the robotic cooking device includes a charging station for recharging the battery of the robotic cooking device. In some embodiments, the robotic cooking device autonomously navigates to the charging station upon the processor detecting a battery level below a predetermined threshold. In some embodiments, the robotic cooking device docks at the charging station when not in use for cooking.

In some embodiments, the robotic cooking device includes autonomously operated cooking tools (e.g., tongs, spatula, rotisserie spit, skewers, wire brush, baster, spoon, fork, whisk, etc.). For instance, the robotic cooking device autonomously rotates a rotisserie spit to cook a whole chicken. In another example, the robotic cooking device autonomous flips burgers using a spatula. In one example, the desired cooking settings for a steak are chosen using the application of the communication device and based on those settings the robotic cooking device uses the tongs to autonomously flip the steak. In some embodiments, the application of the communication device is used to choose when to flip a food item (e.g., after a predetermined amount of time), rotation speed of a spit, when to clean the cooking device using a wire brush, etc.

In some embodiments, the robotic cooking device is used for food delivery services. Examples of robotic devices used for food delivery services are described in U.S. patent application Ser. Nos. 16/230,805, 16/127,038, 62/729,015, and 62/672,878, the entire contents of which are hereby incorporated by reference. In some embodiments, the application of the communication device is used to request delivery of a particular food item to a specified location. In some embodiments, the robotic cooking device cooks the food item in route to the specified delivery location. For example, in some instances, the cooking device of the robotic cooking device includes a wood fire pizza oven and the robotic cooking device bakes the pizza while in route to the specified delivery location. In other examples, the cooking device includes a grill and the robotic cooking device grills steaks in route to the specified delivery location. In another example, the cooking device includes a warming oven or fridge or freezer for maintaining a particular temperature of the food item being delivered. In some embodiments, the application of the communication device is used to view a live video of the food item while being cooked or to check cooking progress of the food item, as described above. In some embodiments, the application of the communication device is used to choose cooking settings and electronic component settings for the food item being delivered, as described above. In some embodiments, wherein multiple robotic cooking devices are included, the robotic cooking device that responds to the request for delivery of a food item depends on multiple factors (e.g., environmental, internal status, etc.), as described in U.S. patent application Ser. No. 16/230,805, the entire contents of which is hereby incorporated by reference. In some embodiments, robotic cooking devices autonomously park when idle, as described in U.S. patent application Ser. No. 16/230,805 as well.

In some embodiments, the robotic cooking device includes an alternative power source. In some embodiments, the power source is a rechargeable battery. In some embodiments, the robotic cooking device includes an electrical plug and obtains power from an electrical outlet. In some embodiments, the robotic cooking device includes solar panels and is powered by solar energy. In other embodiments, the robotic cooking device includes more than one power source.

In some embodiments, components of the robotic cooking device include heat resistant technology to protect them from high temperatures during the cooking process. Examples of heat resistant technology include heat resistant coating or a heat resistant case within which an electronic component can be housed.

In some embodiments, the robotic cooking device can be provided in the form of, for example, a kamado grill and smoker, a dome shaped grill and smoker, a drum barrel grill and smoker, an offset side firebox grill and smoker, a cabinet style grill and smoker, a bullet grill and smoker, and the like.

In some embodiments, the robotic cooking device includes automatically operated hydraulic lifts, such that the processor of the robotic cooking device lifts the cooking device to waist-height during operation and lowers the cooking device when not in use.

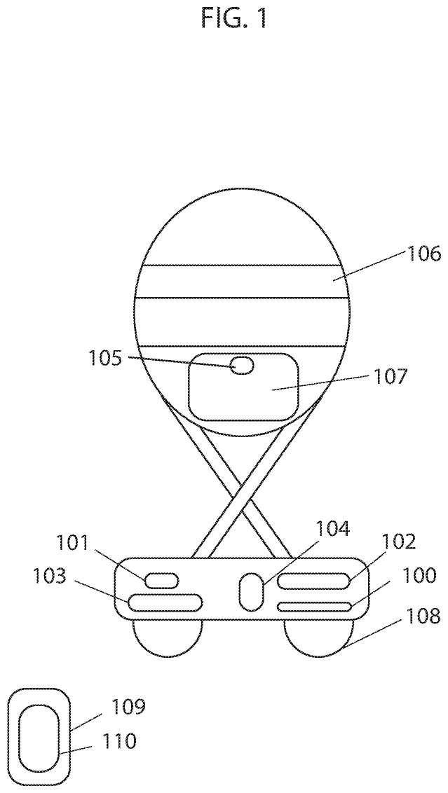

FIG. 1 illustrates an example of a robotic cooking device including processor 100, memory 101, actuator 102, battery 103, sensor 104, electronic component 105 (e.g., fan), grill 106, oven 107, and wheels 108 according to some embodiments. In some embodiments, the robotic cooking device may include the features (and be capable of the functionality) of a robotic cooking device described herein. In some embodiments, program code stored in memory 101 and executed by processor 100 may effectuate the operations described herein. Some embodiments additionally include communication device 109 of a user having a touchscreen 110 and that executes a native application with a graphical user interface by which the user interfaces with the robotic cooking device. While many of the computational acts herein are described as being performed by the robotic cooking device, it should be emphasized that embodiments are also consistent with use cases in which some or all of these computations are offloaded to a separate computing device on a local area network with which the robotic cooking device communicates via a wireless local area network or a remote data center accessed via such networks and the public internet.

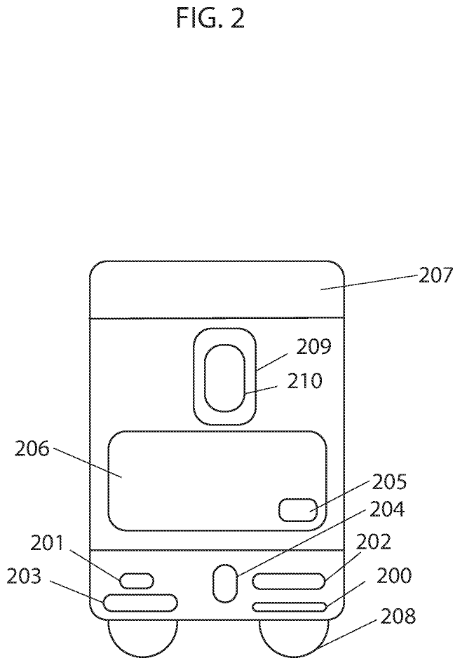

FIG. 2 illustrates an example of a robotic cooking device an example of a robotic cooking device including processor 200, memory 201, actuator 202, battery 203, sensor 204, electronic component 205 (e.g., compressor), mini fridge 206, smoker 207, and wheels 208 according to some embodiments. In some embodiments, the robotic cooking device may include the features (and be capable of the functionality) of a robotic cooking device described herein. In some embodiments, program code stored in memory 201 and executed by processor 200 may effectuate the operations described herein. Some embodiments additionally include a dedicated communication device 209 coupled to the robotic cooking device having a touchscreen 210 and that executes a native application with a graphical user interface by which the user interfaces with the robotic cooking device.

Various embodiments are described herein below, including methods and techniques. It should be kept in mind that the invention might also cover articles of manufacture that include a computer-readable medium on which computer-readable instructions for carrying out embodiments of the inventive technique are stored. The computer-readable medium may include semiconductor, magnetic, opto-magnetic, optical, or other forms of computer-readable medium for storing computer-readable code. Further, the invention may also cover apparatuses for practicing embodiments of the invention. Such apparatus may include circuits, dedicated and/or programmable, to carry out tasks pertaining to embodiments of the invention. Examples of such apparatus include a computer and/or a dedicated computing device when appropriately programmed and may include a combination of a computer/computing device and dedicated/programmable circuits adapted for the various tasks pertaining to embodiments of the invention.

In block diagrams provided herein, illustrated components are depicted as discrete functional blocks, but embodiments are not limited to systems in which the functionality described herein is organized as illustrated. The functionality provided by each of the components may be provided by software or hardware modules that are differently organized than is presently depicted. For example, such software or hardware may be intermingled, conjoined, replicated, broken up, distributed (e.g. within a data center or geographically), or otherwise differently organized. The functionality described herein may be provided by one or more processors of one or more computers executing code stored on a tangible, non-transitory, machine readable medium. In some cases, notwithstanding use of the singular term “medium,” the instructions may be distributed on different storage devices associated with different computing devices, for instance, with each computing device having a different subset of the instructions, an implementation consistent with usage of the singular term “medium” herein. In some cases, third party content delivery networks may host some or all of the information conveyed over networks, in which case, to the extent information (e.g., content) is said to be supplied or otherwise provided, the information may be provided by sending instructions to retrieve that information from a content delivery network.

The reader should appreciate that the present application describes several independently useful techniques. Rather than separating those techniques into multiple isolated patent applications, the applicant has grouped these techniques into a single document because their related subject matter lends itself to economies in the application process. But the distinct advantages and aspects of such techniques should not be conflated. In some cases, embodiments address all of the deficiencies noted herein, but it should be understood that the techniques are independently useful, and some embodiments address only a subset of such problems or offer other, unmentioned benefits that will be apparent to those of skill in the art reviewing the present disclosure. Due to costs constraints, some techniques disclosed herein may not be presently claimed and may be claimed in later filings, such as continuation applications or by amending the present claims. Similarly, due to space constraints, neither the Abstract nor the Summary of the Invention sections of the present document should be taken as containing a comprehensive listing of all such techniques or all aspects of such techniques.

It should be understood that the description and the drawings are not intended to limit the present techniques to the particular form disclosed, but to the contrary, the intention is to cover all modifications, equivalents, and alternatives falling within the spirit and scope of the present techniques as defined by the appended claims. Further modifications and alternative embodiments of various aspects of the techniques will be apparent to those skilled in the art in view of this description. Accordingly, this description and the drawings are to be construed as illustrative only and are for the purpose of teaching those skilled in the art the general manner of carrying out the present techniques. It is to be understood that the forms of the present techniques shown and described herein are to be taken as examples of embodiments. Elements and materials may be substituted for those illustrated and described herein, parts and processes may be reversed or omitted, and certain features of the present techniques may be utilized independently, all as would be apparent to one skilled in the art after having the benefit of this description of the present techniques. Changes may be made in the elements described herein without departing from the spirit and scope of the present techniques as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include”, “including”, and “includes” and the like mean including, but not limited to. As used throughout this application, the singular forms “a,” “an,” and “the” include plural referents unless the content explicitly indicates otherwise. Thus, for example, reference to “an element” or “a element” includes a combination of two or more elements, notwithstanding use of other terms and phrases for one or more elements, such as “one or more.” The term “or” is, unless indicated otherwise, non-exclusive, i.e., encompassing both “and” and “or.” Terms describing conditional relationships, e.g., “in response to X, Y,” “upon X, Y,”, “if X, Y,” “when X, Y,” and the like, encompass causal relationships in which the antecedent is a necessary causal condition, the antecedent is a sufficient causal condition, or the antecedent is a contributory causal condition of the consequent, e.g., “state X occurs upon condition Y obtaining” is generic to “X occurs solely upon Y” and “X occurs upon Y and Z.” Such conditional relationships are not limited to consequences that instantly follow the antecedent obtaining, as some consequences may be delayed, and in conditional statements, antecedents are connected to their consequents, e.g., the antecedent is relevant to the likelihood of the consequent occurring. Statements in which a plurality of attributes or functions are mapped to a plurality of objects (e.g., one or more processors performing steps A, B, C, and D) encompasses both all such attributes or functions being mapped to all such objects and subsets of the attributes or functions being mapped to subsets of the attributes or functions (e.g., both all processors each performing steps A-D, and a case in which processor 1 performs step A, processor 2 performs step B and part of step C, and processor 3 performs part of step C and step D), unless otherwise indicated. Further, unless otherwise indicated, statements that one value or action is “based on” another condition or value encompass both instances in which the condition or value is the sole factor and instances in which the condition or value is one factor among a plurality of factors. Unless otherwise indicated, statements that “each” instance of some collection have some property should not be read to exclude cases where some otherwise identical or similar members of a larger collection do not have the property, i.e., each does not necessarily mean each and every. Limitations as to sequence of recited steps should not be read into the claims unless explicitly specified, e.g., with explicit language like “after performing X, performing Y,” in contrast to statements that might be improperly argued to imply sequence limitations, like “performing X on items, performing Y on the X'ed items,” used for purposes of making claims more readable rather than specifying sequence. Statements referring to “at least Z of A, B, and C,” and the like (e.g., “at least Z of A, B, or C”), refer to at least Z of the listed categories (A, B, and C) and do not require at least Z units in each category. Unless specifically stated otherwise, as apparent from the discussion, it is appreciated that throughout this specification discussions utilizing terms such as “processing,” “computing,” “calculating,” “determining” or the like refer to actions or processes of a specific apparatus, such as a special purpose computer or a similar special purpose electronic processing/computing device. Features described with reference to geometric constructs, like “parallel,” “perpendicular/orthogonal,” “square”, “cylindrical,” and the like, should be construed as encompassing items that substantially embody the properties of the geometric construct, e.g., reference to “parallel” surfaces encompasses substantially parallel surfaces. The permitted range of deviation from Platonic ideals of these geometric constructs is to be determined with reference to ranges in the specification, and where such ranges are not stated, with reference to industry norms in the field of use, and where such ranges are not defined, with reference to industry norms in the field of manufacturing of the designated feature, and where such ranges are not defined, features substantially embodying a geometric construct should be construed to include those features within 15% of the defining attributes of that geometric construct. The terms “first”, “second”, “third,” “given” and so on, if used in the claims, are used to distinguish or otherwise identify, and not to show a sequential or numerical limitation.

The present techniques will be better understood with reference to the following enumerated embodiments:
1. A robotic cooking device comprising: a chassis; a set of wheels; a processor; an actuator; one or more sensors; one or more motors; and one or more cooking devices.
2. The robotic cooking device of embodiment 1, wherein an application of a communication device connected to the robotic cooking device is used for one or more of: choosing settings of the robotic cooking device, choosing a location of the robotic cooking device, adjusting or generating a map of the environment, adjusting or generating a navigation path of the robotic cooking device, adjusting or generating boundaries of the robotic cooking device, and monitoring a food item within the one or more cooking devices.
3. The robotic cooking device of embodiment 2, wherein the communication device is a dedicated communication device coupled to the robotic cooking device.
4. The robotic cooking device of embodiment 2, wherein the communication device is one or more of: a mobile phone, a laptop, a desktop computer, a tablet, or a dedicated remote control.
5. The robotic cooking device of embodiment 2, wherein the settings of the robotic cooking device include one or more of: a food temperature, a temperature within the one or more cooking devices, a cooking time, an operation schedule, a cleaning schedule, a fan speed, a food type, and activating or deactivating the cooking device.
6. The robotic cooking device of embodiments 1-5, wherein one of the one or more sensors comprises one or more temperature sensors for measuring the temperature within the one or more cooking devices.
7. The robotic cooking device of embodiment 6, wherein the processor of the robotic cooking device adjusts the temperature within the cooking device to maintain a predetermined temperature or a temperature set using the application of the communication device.
8. The robotic cooking device of embodiments 1-7, wherein the one or more cooking devices comprises one or more of: a grill, a microwave, an oven, a fridge, a freezer, a smoker, a steamer, a deep fryer, a stove, a smart pot, a crock pot, a hot plate, a warming oven, and a cooler.
9. The robotic cooking device of embodiments 1-8, wherein the robotic cooking device further comprises a fan.
10. The robotic cooking device of embodiment 9, wherein the processor of the robotic cooking device adjusts the fan speed to maintain a predetermined temperature within the cooking device or a temperature within the cooking device set using the application of the communication device.
11. The robotic cooking device of embodiments 1-10, wherein the processor of the robotic cooking device generates a map of the environment by combining data collected by the one or more sensors of the robotic cooking device.
12. The robotic cooking device of embodiments 1-11, wherein the processor of the robotic cooking device localizes the robotic cooking device within a phase space or Hilbert space using data collected by the one or more sensors of the robotic cooking device.
13. The robotic cooking device of embodiments 1-12, wherein an application of a communication device wirelessly connected to the robotic cooking device is used for ordering a food item to a delivery location.
14. The robotic cooking device of embodiment 13, wherein the food item is cooked in route to the delivery location.
15. The robotic cooking device of embodiment 13, wherein the application of the communication device is used for one or more of: monitoring a cooking progress of the food item and monitoring a current location of the robotic cooking device.
16. The robotic cooking device of embodiment 2, wherein cooking settings for a food item are chosen and saved using the application of the communication device.
17. The robotic cooking device of embodiment 2, wherein the application of the communication device is used for choosing a food item to cook.
18. The robotic cooking device of embodiment 17, wherein default or previously saved cooking settings for the food item selected are used by the robotic cooking device to cook the food item.
19. The robotic cooking device of embodiments 1-18, wherein the robotic cooking device further comprises one or more cooking tools comprising at least one of: tongs, spatula, rotisserie spit, skewers, wire brush, baster, spoon, fork, and whisk.
20. The robotic cooking device of embodiment 19, wherein the robotic cooking device autonomously uses the one or more cooking tools to cook a food item.

1. A robotic cooking device comprising:
a chassis;
a set of wheels;
a processor;
an actuator;
one or more sensors;
one or more motors; and
one or more cooking devices.

2. The robotic cooking device of claim 1, wherein an application of a communication device connected to the robotic cooking device is used for one or more of: choosing settings of the robotic cooking device, choosing a location of the robotic cooking device, adjusting or generating a map of the environment, adjusting or generating a navigation path of the robotic cooking device, adjusting or generating boundaries of the robotic cooking device, and monitoring a food item within the one or more cooking devices.

3. The robotic cooking device of claim 2, wherein the communication device is a dedicated communication device coupled to the robotic cooking device.

4. The robotic cooking device of claim 2, wherein the communication device is one or more of: a mobile phone, a laptop, a desktop computer, a tablet, or a dedicated remote control.

5. The robotic cooking device of claim 2, wherein the settings of the robotic cooking device include one or more of: a food temperature, a temperature within the one or more cooking devices, a cooking time, an operation schedule, a cleaning schedule, a fan speed, a food type, and activating or deactivating the cooking device.

6. The robotic cooking device of claim 1, wherein one of the one or more sensors comprises one or more temperature sensors for measuring the temperature within the one or more cooking devices.

7. The robotic cooking device of claim 6, wherein the processor of the robotic cooking device adjusts the temperature within the cooking device to maintain a predetermined temperature or a temperature set using the application of the communication device.

8. The robotic cooking device of claim 1, wherein the one or more cooking devices comprises one or more of: a grill, a microwave, an oven, a fridge, a freezer, a smoker, a steamer, a deep fryer, a stove, a smart pot, a crock pot, a hot plate, a warming oven, and a cooler.

9. The robotic cooking device of claim 1, wherein the robotic cooking device further comprises a fan.

10. The robotic cooking device of claim 9, wherein the processor of the robotic cooking device adjusts the fan speed to maintain a predetermined temperature within the cooking device or a temperature within the cooking device set using the application of the communication device.

11. The robotic cooking device of claim 1, wherein the processor of the robotic cooking device generates a map of the environment by combining data collected by the one or more sensors of the robotic cooking device.

12. The robotic cooking device of claim 1, wherein the processor of the robotic cooking device localizes the robotic cooking device within a phase space or Hilbert space using data collected by the one or more sensors of the robotic cooking device.

13. The robotic cooking device of claim 1, wherein an application of a communication device wirelessly connected to the robotic cooking device is used for ordering a food item to a delivery location.

14. The robotic cooking device of claim 13, wherein the food item is cooked in route to the delivery location.

15. The robotic cooking device of claim 13, wherein the application of the communication device is used for one or more of: monitoring a cooking progress of the food item and monitoring a current location of the robotic cooking device.

16. The robotic cooking device of claim 2, wherein cooking settings for a food item are chosen and saved using the application of the communication device.

17. The robotic cooking device of claim 2, wherein the application of the communication device is used for choosing a food item to cook.

18. The robotic cooking device of claim 17, wherein default or previously saved cooking settings for the food item selected are used by the robotic cooking device to cook the food item.

19. The robotic cooking device of claim 1, wherein the robotic cooking device further comprises one or more cooking tools comprising at least one of: tongs, spatula, rotisserie spit, skewers, wire brush, baster, spoon, fork, and whisk.

20. The robotic cooking device of claim 19, wherein the robotic cooking device autonomously uses the one or more cooking tools to cook a food item.
